(19) United States
(12) Patent Application Publication
(10) Pub. No.: US 2012/0152224 A1
(43) Pub. Date: Jun. 21, 2012

(54) VENTING SYSTEM FOR COOKING APPLIANCE

(75) Inventors: John Mark Chilton, Campbellsburg, KY (US); Philip Ames Barber, Louisville, KY (US); Octavio Lugo Castillo, Queretaro (MX); Gerardo Picon, Queretaro (MX); Luis Angel, Queretaro (MX)

(73) Assignee: GENERAL ELECTRIC COMPANY, Schenectady, NY (US)

(21) Appl. No.: 12/968,779

(22) Filed: Dec. 15, 2010

(51) Int. Cl. A21B 1/00

(52) U.S. Cl. 126/21 R

(57) ABSTRACT

A venting system for a cooking appliance having multiple ovens is provided. The venting system maintains separate ventilation between different ovens so that the gases from one oven are not introduced into the other oven(s). The venting system can be installed within the limited space available within the appliance cabinet or can be installed outside of the cabinet.

### FIELD OF THE INVENTION

The present invention relates to a venting system for a cooking appliance and, more particularly, to a venting system for an appliance having multiple ovens.

### BACKGROUND OF THE INVENTION

The operation of an oven for the cooking of food typically creates gases including steam and cooking fumes. The high temperatures needed to cook the food causes moisture in the food to be released. Additionally, such temperatures cause the food to release by-products and other gases contributing to the aroma that is generally associated with cooking.

While it is generally desirable to maintain heat within an oven during the cooking process, the gaseous products of cooking must be vented. Without venting, the trapped gases can have an undesirable impact on food taste and can leave undesirable deposits inside the oven that would require removal and cleaning. In an extreme case, excess steam within the oven cavity can create problems with achieving the appropriate crispness and/or texture for some foods such as breads and cakes.

Modern cooking oven appliances are frequently offered with a dual oven arrangement. Specifically, both an upper oven and a lower oven are may be provided in an appliance that may be e.g., a free standing range with a cook top or may come in a double oven configuration that is mounted within, or slides into, a cabinet. Consumers frequently seek double oven arrangements as a matter of convenience in that such configurations allow e.g., cooking multiple different foods that require different cooking temperatures and/or allow for cooking with one oven while warming the food with the other oven.

The use of multiple ovens within the same appliance creates challenges in properly venting the ovens. When both ovens are in use at the same time, it is generally desirable to keep the fumes from each oven separate. More particularly, preferably the fumes and steam from one oven are not vented or channeled into another oven. Such a configuration could e.g., lead to an undesirable impact on cooking and the taste of the foods being cooked.

In addition, the space provided for most ovens is typically standardized by custom and/or building codes. However, consumers commonly wish to maximize the amount of cooking space available within an oven. The space available within an oven appliance between its outer cabinet and the walls of the oven compartment is increasingly smaller as designers attempt to maximize the space available for food within the oven compartment while remaining within certain limits on the overall size of the appliance. Thus, the space remaining between the cabinet and the oven compartment is very confined, particularly with the addition of other features sought by consumers. This aspect of oven construction greatly limits the space available for venting.

Accordingly, a system for venting of a cooking appliance would be useful. More particularly, a system that allows for the venting of a cooking appliance having multiple ovens would be beneficial. Such a system that allows for separate venting of the fumes from each oven while remaining within the narrow confines of the appliance cabinet and/or kitchen space available for installation would also be particularly useful.

### BRIEF DESCRIPTION OF THE INVENTION

Aspects and advantages of the invention will be set forth in part in the following description, or may be obvious from the description, or may be learned through practice of the invention.

In one exemplary embodiment, the present invention provides an oven appliance for cooking. The oven appliance includes a cabinet defining an exterior and interior of the appliance. A lower oven cavity and an upper oven cavity are positioned within the interior of the cabinet. Each cavity is configured for the receipt of food for cooking. A lower vent extends upwardly from the lower oven cavity to the exterior of the cabinet. The lower vent has a lower vent inlet for the receipt of gases from the lower oven cavity. The lower vent also has a lower vent outlet for the egress of gases from the lower oven cavity to the exterior of the appliance. An upper vent extends upwardly from the upper oven cavity to the exterior of the cabinet and separately from the lower vent. The upper vent has an upper vent inlet for the receipt of gases from the upper oven cavity. The upper vent has at least one upper vent outlet for the egress of gases from the upper oven cavity to the exterior of the appliance.

In another exemplary embodiment, the present invention provides another oven appliance for cooking. The oven includes a cabinet defining an exterior and interior of the appliance. A lower oven cavity and an upper oven cavity are positioned within the interior of the cabinet. Each cavity is configured for the receipt of food for cooking. A lower vent extends upwardly from the lower oven cavity to the exterior of the cabinet. The lower vent has a lower vent inlet for the receipt of gases from the lower oven cavity. The lower vent also has at least one lower vent outlet for the egress of gases from the lower oven cavity to the exterior of the appliance. An upper vent extends upwardly from the upper oven cavity to the exterior of the cabinet and separately from the lower vent. The upper vent has an upper vent inlet for the receipt of gases from the upper oven cavity. The upper vent has an upper vent outlet for the egress of gases from the upper oven cavity to the exterior of the appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective, front view of an exemplary embodiment of the invention in the form of a free standing range with a cook top and double oven arrangement.

FIG. 2 provides a partial, cross-sectional view of the exemplary embodiment FIG. 1 showing an exemplary venting arrangement.

FIG. 3 provides a perspective, front view of another exemplary embodiment of the invention in the form of a free standing range with a cook top and double oven arrangement.

FIG. 4 provides a partial, cross-sectional view of the exemplary embodiment FIG. 3 showing an exemplary venting arrangement.

FIG. 5 provides a partial, cross-sectional view of another exemplary embodiment of the present invention.

As used in the figures, identical reference numerals between figures indicate the same or analogous features.

### DETAILED DESCRIPTION OF THE INVENTION

The present invention provides a venting system for a cooking appliance having multiple ovens. More particularly, a venting system is provided that maintains separate ventilation between different ovens so that the gases from one oven are not introduced into the other oven(s). The venting system can be installed within the limited space available within the appliance cabinet or can be installed externally as well. Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

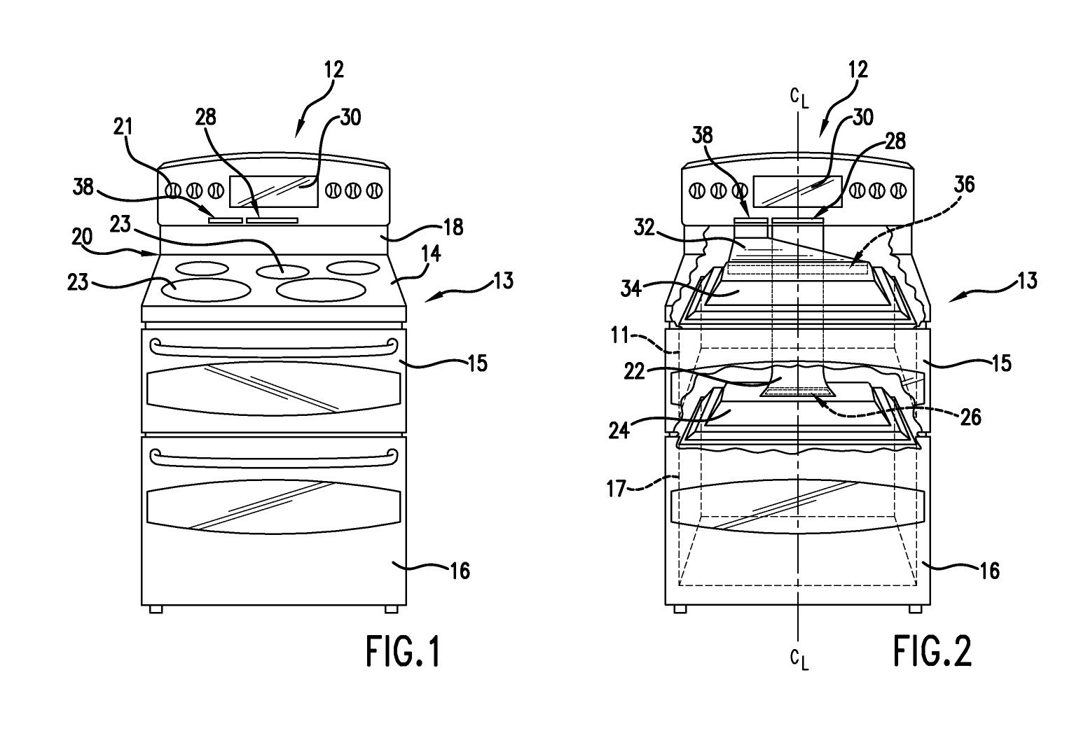

FIGS. 1 and 2 illustrate a free-standing range appliance 12 that includes an exemplary embodiment of a venting system for the handling of gases created during cooking. Appliance 12 is provided by way of example only. The present invention may be used with other cooking appliances regardless of whether such are free-standing. For example, the present invention can be used with ovens that are installed into cabinets such as a double oven installation, slide-in installations, and other configurations as well. Cooking appliances that are powered by gaseous fuels, electricity, or a combination thereof may also be used.

For the exemplary embodiment of FIGS. 1 and 2, range 12 includes an outer body or cabinet 13 that incorporates a generally rectangular cook top 14. An upper oven cavity 11, not shown in detail, is positioned below cook top 14 within the interior of cabinet 13. Upper oven cavity 11 has a front-opening access door 16. Similarly, a lower oven cavity 17, not shown in detail, is positioned below upper oven cavity 11 within the interior of cabinet 13 and has a front-opening access door 17. Each oven cavity 11 and 17 are configured with heating elements, racks, and other features for the cooking of food received into the cavities.

A range backsplash 18 extends upward of a rear edge 20 of cook top 14 and contains various control selectors 21 for selecting operative features of five heating elements 23 on cook top 14 and the ovens 11 and 17. Each heating element 23 provides a flat surface thereon for supporting cooking vessels and utensils during cooking of meal preparations placed therein. For purposes of describing the invention, five heating elements 23 as might be used on a kitchen cooking appliance 12 are depicted. However, using the teachings disclosed herein, one of skill in the art will understand that the present invention may be used with e.g., a different number of heating elements 23 that are powered by gas burners or electric heating elements.

Backsplash 18 also includes a display 30 that may be provided with a variety of features for appliance 12. Display 30 may include a clock, timer, temperature information, and other features as desired. Also, a variety of other electronic features can also be provided with appliance 12 that may or may not require use of display 30. For example, in the case of a gas fuel, appliance 12 may have various gas detection sensors throughout appliance 12 to determine whether a leak is present. Such features, along with the oven, may be controlled by an electronic range control that may include one or more processing devices.

Referring more specifically now to FIG. 2, a lower vent 22 extends upwardly from a top 24 of lower oven cavity 17 to the exterior of cabinet 13. More specifically, lower vent 22 has a lower vent inlet 26 for the receipt of gases from food being cooked in the lower oven cavity 17. Lower vent 22 also has a lower vent outlet 28 to allow for the escape of gases collected from the lower oven cavity 17. For this particular embodiment, lower vent outlet 28 is located in backsplash 18 below display 30. However, other locations for lower vent outlet 28 may also be utilized as well.

An upper vent 32 extends upwardly from a top 34 of upper oven cavity 11 to the exterior of cabinet 13. More specifically, upper vent 32 has an upper vent inlet 36 for the receipt of gases from food being cooked in the upper oven cavity 11. Upper vent 32 also has an upper vent outlet 38 to allow for the escape of gases collected from the upper oven cavity 11. As with lower vent outlet 28, upper vent outlet 38 is located in backsplash 18 below display 30 for the embodiment of FIGS. 1 and 2, but other locations for upper vent outlet 38 may also be selected.

As shown in FIGS. 1 and 2, for this exemplary embodiment, lower vent 22 is placed in a position along the centerline of appliance 12. Accordingly, lower vent inlet 26 is also substantially symmetrical about the centerline of the appliance 12. In order to create a uniform or more even flow of gases out of the lower oven cavity 17 through lower vent 22, it is preferable to place the lower vent inlet 26 along the centerline of the appliance 12 or, more specifically, along the centerline of the lower oven cavity 17. For the embodiments of FIGS. 1 through 5, the centerline of appliance 12 is identical to the centerlines of the upper and lower oven cavities 11 and 17. However, the present invention includes embodiments whether the centerlines of the oven cavities may be different than the appliance in which the cavities are located. While lower vent inlet 26 is shown in the top 24 of the lower oven cavity 17, it should be understood that lower vent inlet 26 could also be placed in other locations such as e.g., along a rear wall of appliance 12.

Upper vent 32 has an upper vent inlet 36 that is placed along the centerline of the upper oven cavity 11. However, the upper vent 32 angles to one side of appliance 12 such that upper vent outlet 38 is positioned to one side of the centerline (to the reader's left for FIGS. 1 and 2). Upper vent outlet 38 can be placed on either side of the centerline. Again, the centering of the upper vent inlet 26 is preferred for maintaining a uniform flow of gas from the upper oven cavity 11. While upper vent inlet 36 is shown in the top 34 of upper oven cavity 11, it should be understood that upper vent inlet 36 could also be placed in other locations such as e.g., along a rear wall of appliance 12.

Preferably, upper vent 32 and lower vent 22 are routed within cabinet 13 of appliance 12, in the limited space available between the oven cavities 11 and 17 and cabinet 13. Importantly, vents 22 and 32 are separate from one another in that such are not combined into the same duct nor is one contained within the other. Such feature is important to provide ample passage for the escape of air from each oven cavity 11 and 17, and for preventing the gas escaping from one oven cavity into the other oven cavity during cooking so as to avoid contamination of different foods, residue build-up, and/or other undesirable effects. It should be understood that vents 22 and 32 could also be positioned along the exterior (i.e. outside of) cabinet 13 as well if desired.

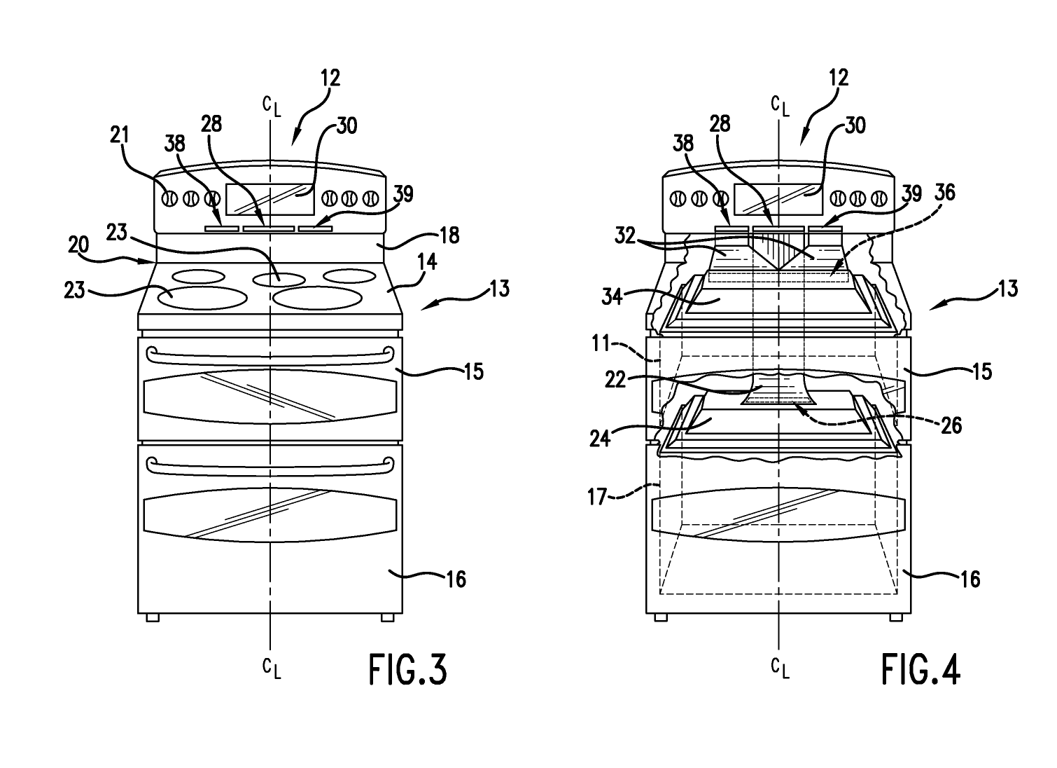

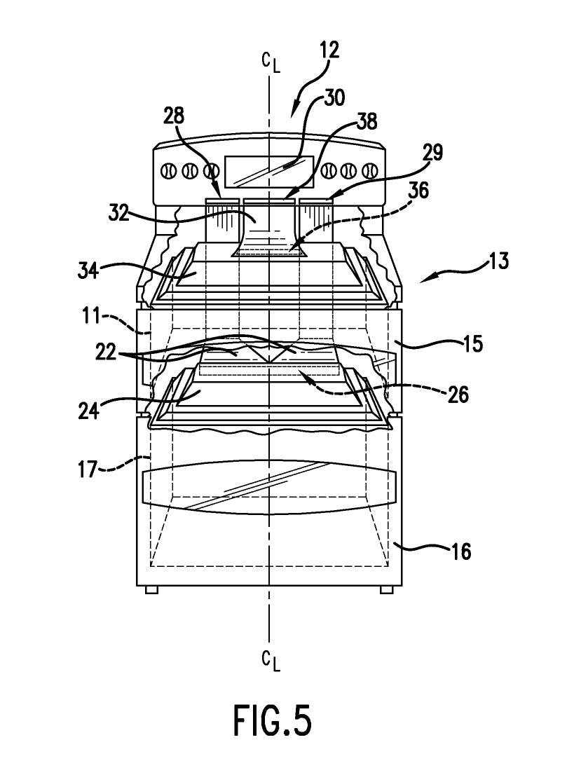

FIGS. 3 and 4 provide another exemplary embodiment of the present invention in which identical reference numerals indicate the same or somewhat similar features to those shown in FIGS. 1 and 2. For this embodiment, lower vent 22 still extends from lower oven cavity 17 with a lower vent inlet 26 that is symmetrical about the centerline of oven cavity 17. Similarly, upper vent 32 also an upper vent inlet 26 that is symmetrical about the centerline of upper oven cavity 11. However, in a manner different from the embodiment of FIGS. 1 and 2, upper vent 32 diverges into an upper vent outlet 38 and an upper vent outlet 39 so as to increase the cross-sectional area available for the egress of oven gas from upper vent 32. As shown, upper vent outlets 38 and 39 are positioned along backsplash 18 along either side of lower vent outlet 28.

FIG. 5 provides another exemplary embodiment of the present invention that could be considered as a reverse of FIGS. 3 and 4. More particularly, for this embodiment, lower vent 22 still extends from lower oven cavity 17 with a lower vent inlet 26 that is symmetrical about the centerline of oven cavity 17. However, in a manner different from the embodiment of FIGS. 3 and 5, lower vent 22 diverges into a lower vent outlet 28 and a lower vent outlet 29 so as to increase the cross-sectional area available for the egress of oven gas from lower vent 22. As shown, lower vent outlets 28 and 29 are positioned along backsplash 18 along either side of upper vent outlet 38. Upper vent 32 also has an upper vent inlet 36 that is symmetrical about the centerline of upper oven cavity 11.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An oven appliance for cooking, comprising:
a cabinet defining an exterior and interior of the appliance;
a lower oven cavity and an upper oven cavity positioned within the interior of said cabinet, each cavity configured for the receipt of food for cooking;
a lower vent extending upwardly from said lower oven cavity to the exterior of the cabinet, said lower vent having a lower vent inlet for the receipt of gases from said lower oven cavity, said lower vent having a lower vent outlet for the egress of gases from said lower oven cavity to the exterior of the appliance; and
an upper vent extending upwardly from said upper oven cavity to the exterior of the cabinet and separately from said lower vent; said upper vent having an upper vent inlet for the receipt of gases from said upper oven cavity, said upper vent having at least one upper vent outlet for the egress of gases from said upper oven cavity to the exterior of the appliance.

2. An oven appliance for cooking as in claim 1, said lower oven cavity defining a centerline, and wherein said lower vent is substantially symmetrical along the centerline of said lower oven cavity.

3. An oven appliance for cooking as in claim 2, said upper oven cavity defining a centerline, and wherein the upper vent inlet is substantially symmetrical about the centerline of said upper oven cavity.

4. An oven appliance for cooking as in claim 3, wherein the at least one upper vent outlet is positioned to one side of said lower vent outlet.

5. An oven appliance for cooking as in claim 4, wherein the at least one upper vent outlet is positioned along a backsplash of the appliance.

6. An oven appliance for cooking as in claim 3, wherein said upper vent has two upper vent outlets, and where the two upper vent outlets are positioned in an opposing manner about the lower vent outlet.

7. An oven appliance for cooking as in claim 6, wherein the upper vent inlet is positioned near the top of the upper oven cavity.

8. An oven appliance for cooking as in claim 6, wherein the two upper vent outlets are positioned along a backsplash of the appliance.

9. An oven appliance for cooking as in claim 1, further comprising a cook top having a plurality of burners.

10. An oven appliance for cooking, comprising:
a cabinet defining an exterior and interior of the appliance;
a lower oven cavity and an upper oven cavity positioned within the interior of said cabinet, each cavity configured for the receipt of food for cooking;
a lower vent extending upwardly from said lower oven cavity to the exterior of the cabinet, said lower vent having a lower vent inlet for the receipt of gases from said lower oven cavity, said lower vent having at least one lower vent outlet for the egress of gases from said lower oven cavity to the exterior of the appliance; and
an upper vent extending upwardly from said upper oven cavity to the exterior of the cabinet and separately from said lower vent; said upper vent having an upper vent inlet for the receipt of gases from said upper oven cavity, said upper vent having an upper vent outlet for the egress of gases from said upper oven cavity to the exterior of the appliance.

11. An oven appliance for cooking as in claim 10, said upper oven cavity defining a centerline, and wherein said upper vent is substantially symmetrical along the centerline of said upper oven cavity.

12. An oven appliance for cooking as in claim 11, said lower oven cavity defining a centerline, and wherein the lower vent inlet is substantially symmetrical about the centerline of said lower oven cavity.

13. An oven appliance for cooking as in claim 12, wherein the at least one lower vent outlet is positioned to one side of the upper vent outlet.

14. An oven appliance for cooking as in claim 13, wherein the at least one lower vent outlet is positioned along a backsplash of the appliance.

15. An oven appliance for cooking as in claim 12, wherein said lower vent has two lower vent outlets, and where the two lower vent outlets are positioned in an opposing manner about the upper vent outlet.

16. An oven appliance for cooking as in claim 15, wherein the lower vent inlet is positioned near the top of the lower oven cavity.

17. An oven appliance for cooking as in claim 15, wherein the two lower vent outlets are positioned along a backsplash of the appliance.

18. An oven appliance for cooking as in claim 10, further comprising a cook top having a plurality of burners.
